(19) United States
(12) Patent Application Publication
(10) Pub. No.: US 2024/0241847 A1
(43) Pub. Date: Jul. 18, 2024

(54) ACCELERATION OF NETWORK INTERFACE DEVICE TRANSACTIONS USING COMPUTE EXPRESS LINK

(71) Applicant: Intel Corporation, Santa Clara, CA (US)

(72) Inventors: Min Zhang, Shanghai (CN); Di Pei, Minhang Distric (CN); Gang Cao, Shanghai (CN); Changpeng Liu, Shanghai (CN); Ziye Yang, Shanghai (CN)

(73) Assignee: Intel Corporation, Santa Clara, CA (US)

(21) Appl. No.: 18/619,778

(22) Filed: Mar. 28, 2024

(30) Foreign Application Priority Data
Feb. 19, 2024 (WO) PCT/CN2024/077549

(51) Int. Cl. G06F 13/28; G06F 13/16

(52) U.S. Cl. CPC G06F 13/28; G06F 13/1668; G06F 2213/2806

(57) ABSTRACT

A network interface device includes a port with protocol circuitry to couple to a host device by a link compliant with a Compute Express Link (CXL) protocol. The network interface device further includes a memory and logic to support emulation of a file system by the host device of at least a portion of the memory, where the link is used for direct memory accesses for requests or responses associated with the emulation of the file system.

### RELATED APPLICATIONS

This application claims the benefit of priority under 35 U.S.C. § 119(b) to Patent Cooperation Treaty (PCT) International Application No. PCT/CN2024/077549, filed Feb. 19, 2024, which is hereby incorporated by reference in its entirety.

### FIELD

The present disclosure relates in general to the field of distributed computing systems, and more specifically, to data transfers involving network interface devices.

### BACKGROUND

A datacenter may include one or more platforms, where the platforms include at least one processor and associated memory modules. Platforms in the datacenter may facilitate the performance of any suitable number of processes associated with various applications running on the platform. These processes may be performed by the processors and other associated logic of the platforms. Platforms may additionally include I/O controllers, such as network adapter devices, which may be used to send and receive data on a network for use by the various applications.

### BRIEF DESCRIPTION OF THE DRAWINGS

FIG. 1 illustrates a simplified block diagram illustrating example components of a data center.

FIG. 2 illustrates a simplified block diagram illustrating a computing system including a network interface device.

FIG. 3A illustrates a simplified block diagram of an example computing system utilizing a link compliant with a Compute Express Link (CXL)-based protocol.

FIG. 3B illustrates a simplified block diagram of example protocol circuitry.

FIGS. 4A-4C are simplified block diagram illustrating example CXL device configurations.

FIG. 5 is a simplified block diagram illustrating an example data center cluster.

FIG. 6 is a simplified block diagram illustrating an example network interface device coupled to one or more host devices.

FIG. 7 is a simplified block diagram illustrating an example data flow in a conventional network interface device.

FIG. 8 is a simplified block diagram illustrating an example enhanced network interface device.

FIGS. 9-12 are simplified block diagram illustrating example data flows using an enhanced network interface device.

FIG. 13 is a simplified block diagram illustrating an example emulation of a file system using a network interface device.

FIG. 14 illustrates a block diagram of an example processor device in accordance with certain embodiments.

### DETAILED DESCRIPTION

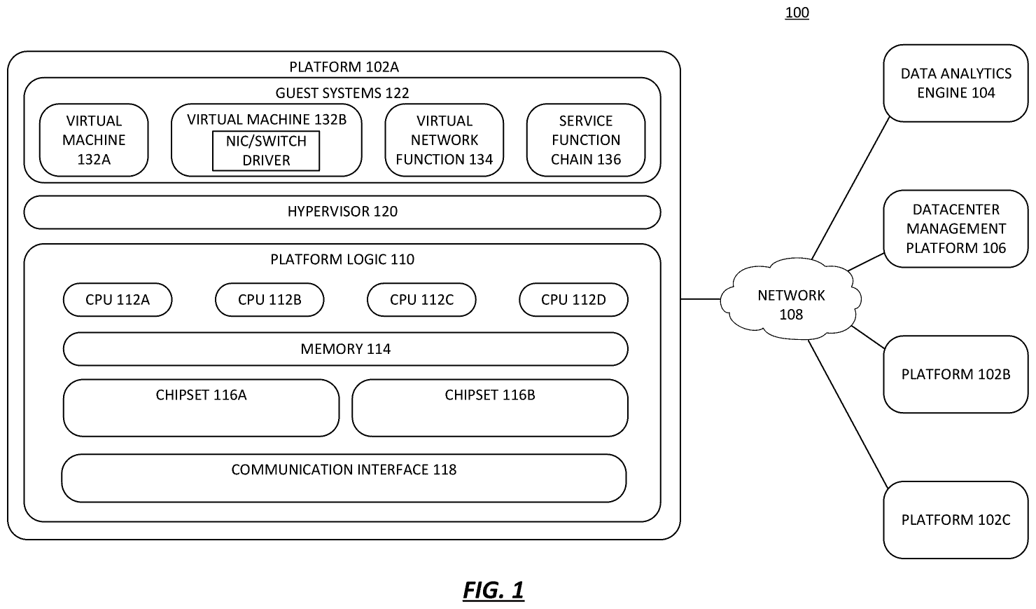

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such clusters more efficient, among other example enhancements.

Computing platforms 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may include any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may include memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. A chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on the CPUs.

Chipsets 116 may include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. A platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the datacenter 100 may be coupled together in any suitable manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

In an improved system implementation, a data center cluster may be implemented utilizing the CXL-based communication channels. For instance, a CXL-based data center cluster may include a number of host computers coupled to a CXL-based switch. Traffic within the cluster and between clusters may be implemented utilizing a network processor device (e.g., a smart network interface controller (NIC), data processing unit (DPU), infrastructure processing unit (IPU), programmable networking device, etc.), which is connected to the CXL-based switch. Local memory of the network processor device may be utilized to construct a shared memory pool for the cluster, which can be leveraged to facilitate efficient data transfers utilizing CXL. CXL enables a more efficient data transmission than TCP and RDMA between the processors and accelerators of the cluster. The network processor device may be configured with logic (implemented in hardware, firmware, and/or software) to perform near-data processing for the cluster and reduce the memory movement, to thereby provide more efficient performance in an improved service mesh cluster architecture. Such an architecture can be used to implement data center clusters with reduced memory movement between hosts, lower latency, improved resource utilization, and lower power consumption, among other example benefits.

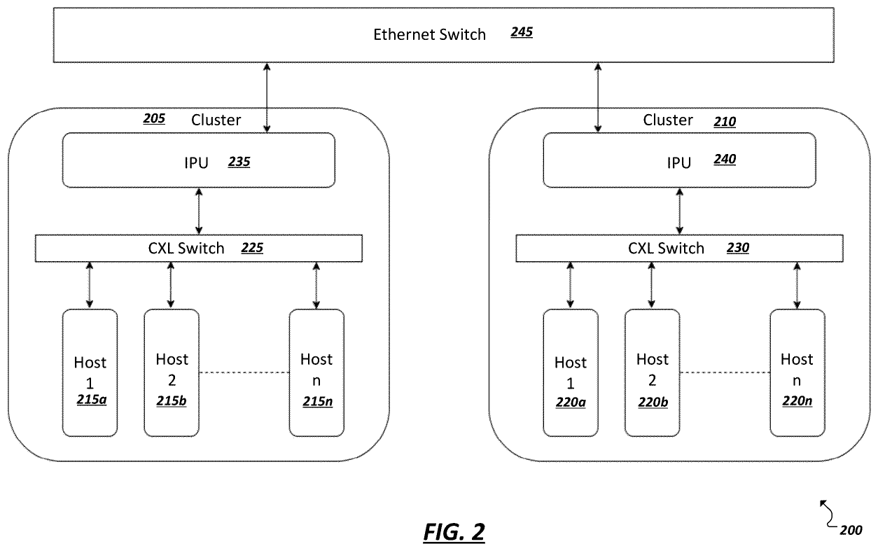

Networking processing devices, such as IPUs, smart NICs, or other network processing elements may be utilized within computing systems to enhance the performance of elements within a computing network, system, or platform. For instance, FIG. 2 is a simplified block diagram 200 illustrating an example implementation of an improved data center cluster architecture. In this example, clusters 205, 210 are shown, the clusters implemented to include respective host computing devices (e.g., 215a-n, 220a-n) coupled to a switch 225, 230 in the cluster 205, 210. A cluster 205, 210 may further include a network interface device (e.g., an IPU or smart NIC) 235, 240 to manage the corresponding cluster (e.g., 205, 210). Further, the network interface devices (e.g., 235, 240) of the various clusters (e.g., 205, 210) may be interconnected with other network interface devices of other clusters, for instance, using an Ethernet or other interconnect. For instance, one or more switches (e.g., Ethernet switch 245) may be utilized to facilitate such an inter-cluster network.

As shown in the example of FIG. 2, a single service mesh cluster (e.g., 205) may be equipped with a switch 225 (e.g., a CXL switch) and network interface device 235, and the servers (e.g., hosts 215a-n) belonging to this cluster are connected to the CXL switch 225 and network interface device 235. The scalability of host servers may vary from cluster to cluster, with clusters capable of including various numbers of host server system based on the dimensions of the CXL switch (e.g., implemented as one rack of servers or multiple racks, etc.). A service mesh may be composed of one cluster or multiple interconnected clusters, such as illustrated in the example of FIG. 2. Cross-cluster connections are managed by the network interface device through the inter-cluster switch (e.g., 245). Additionally, the cluster's network interface device (e.g., 235, 240) may be additionally tasked with handling the ingress and egress traffic of the cluster and distribute the requests between the host servers (e.g., 215a-n) inside the cluster (e.g., 205). In some implementations, microservices may be hosted by various host server systems within an example service mesh, among other example applications.

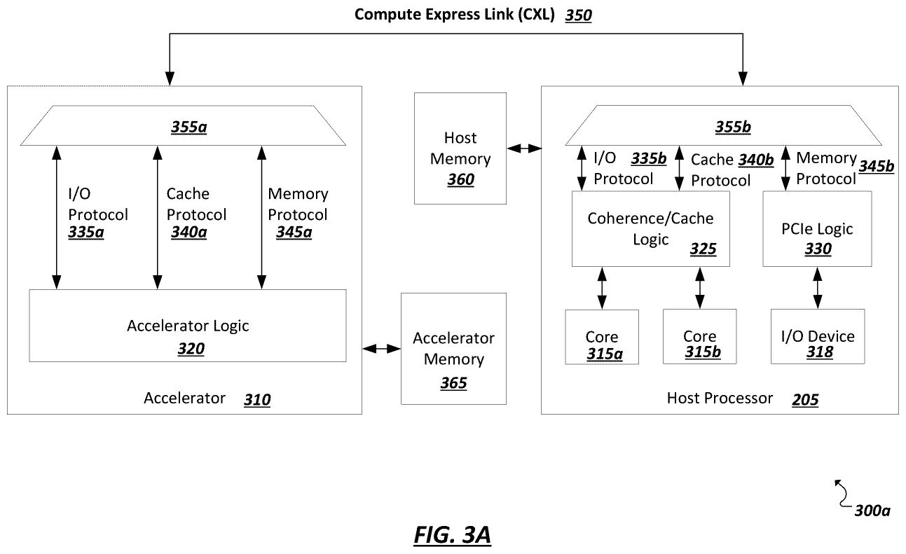

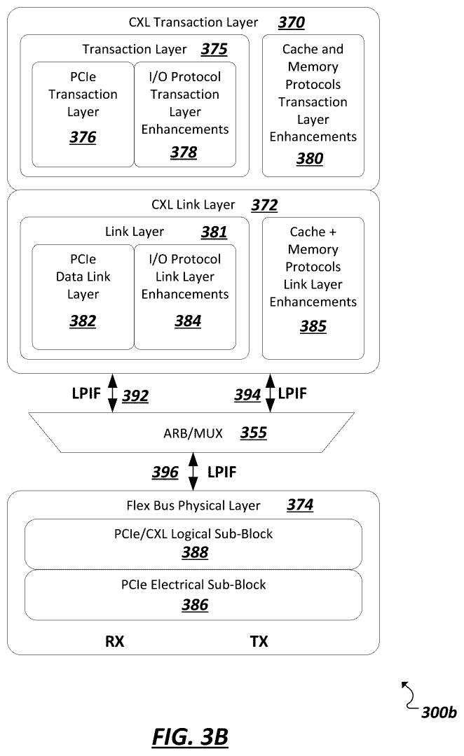

Various interconnect protocols may be utilized to interconnect network interface devices with other computing devices in a cluster. In some implementations, Compute Express Link (CXL)-based protocols may be utilized to enhance performance of communications between devices coupled point-to-point or within a network. FIGS. 3A-3B are simplified block diagrams illustrating example protocol logic, implemented in hardware and/or software, to implement a Compute Express Link (CXL) protocol (e.g., in one or more ports of a device within a system). It should be appreciated, that while much of the discussion centers on features provided by a CXL-protocol and communication channels compliant with CXL, that other substitute protocols with similar, comparable features may be substituted for CXL in the embodiments discussed below. The CXL interconnect protocol is designed to provide an improved, high-speed CPU-to-device and CPU-to-memory interconnect designed to accelerate next-generation data center performance, among other applications. CXL maintains memory coherency between the CPU memory space and memory on attached devices, which allows resource sharing for higher performance, reduced software stack complexity, and lower overall system cost, among other example advantages. CXL enables communication between host processors (e.g., CPUs) and a set of workload accelerators (e.g., graphics processing units (GPUs), field programmable gate array (FPGA) devices, tensor and vector processor units, machine learning accelerators, networking accelerators, purpose-built accelerator solutions, among other examples). Indeed, CXL is designed to provide a standard interface for high-speed communications, as accelerators are increasingly used to complement CPUs in support of emerging computing applications such as artificial intelligence, machine learning and other applications.

A CXL link may be a low-latency, high-bandwidth discrete or on-package link that supports dynamic protocol multiplexing of coherency, memory access, and input/output (I/O) protocols. Among other applications, a CXL link may enable an accelerator to access system memory as a caching agent and/or host system memory, among other examples. CXL is a dynamic multi-protocol technology designed to support a vast spectrum of accelerators. CXL provides a rich set of sub-protocols that include I/O semantics similar to PCIe (CXL.io), caching protocol semantics (CXL.cache), and memory access semantics (CXL.mem) over a discrete or on-package link. Based on the particular accelerator usage model, all of the CXL protocols or only a subset of the protocols may be enabled. In some implementations, CXL may be built upon the well-established, widely adopted PCIe infrastructure (e.g., PCIe 5.0, PCIe 6.0, etc.), leveraging the PCIe physical and electrical interface to provide advanced protocol in areas include I/O, memory protocol (e.g., allowing a host processor to share memory with an accelerator device), and coherency interface.

Turning to FIG. 3A, a simplified block diagram 300a is shown illustrating an example system utilizing a CXL link 350. For instance, the link 350 may interconnect a host processor 305 (e.g., CPU) to an accelerator device 310. In this example, the host processor 305 includes one or more processor cores (e.g., 315a-b) and one or more I/O devices (e.g., 318). Host memory (e.g., 360) may be provided with the host processor (e.g., on the same package or die). The accelerator device 310 may include accelerator logic 320 and, in some implementations, may include its own memory (e.g., accelerator memory 365). In this example, the host processor 305 may include circuitry to implement coherence/cache logic 325 and interconnect logic (e.g., PCIe logic 330). CXL multiplexing logic (e.g., 355a-b) may also be provided to enable multiplexing of CXL protocols (e.g., I/O protocol 335a-b (e.g., CXL.io), caching protocol 340a-b (e.g., CXL.cache), and memory access protocol 345a-b (CXL.mem)), thereby enabling data of any one of the supported protocols (e.g., 335a-b, 340a-b, 345a-b) to be sent, in a multiplexed manner, over the link 350 between host processor 305 and accelerator device 310.

In some implementations, a Flex Bus™ port may be utilized in concert with CXL-compliant links to flexibly adapt a device to interconnect with a wide variety of other devices (e.g., other processor devices, accelerators, switches, memory devices (e.g., near memory, far memory, pooled memory, tiered memory, cache, etc.), among other examples). A Flex Bus port is a flexible high-speed port that is statically configured to support either a PCIe or CXL link (and potentially also links of other protocols and architectures). A Flex Bus port allows designs to choose between providing native PCIe protocol or CXL over a high-bandwidth, off-package link. Selection of the protocol applied at the port may happen during boot time via auto negotiation and be based on the device that is plugged into the slot. Flex Bus uses PCIe electricals, making it compatible with PCIe retimers, and adheres to standard PCIe form factors for an add-in card.

FIG. 3B is a simplified block diagram 300b illustrating an example protocol stack and associated logic (implemented in hardware and/or software) utilized to implement CXL links. For instance, the protocol logic may be organized as multiple layers to implement the multiple protocols supported by the port. For instance, a port may include transaction layer logic (e.g., 370), link layer logic (e.g., 372), and physical layer logic (e.g., 374) (e.g., implemented all or in-part in circuitry). For instance, a transaction (or protocol) layer (e.g., 370) may be subdivided into transaction layer logic 375 that implements a PCIe transaction layer 376 and CXL transaction layer enhancements 378 (for CXL.io) of a base PCIe transaction layer 376, and logic 380 to implement cache (e.g., CXL.cache) and memory (e.g., CXL.mem) protocols for a CXL link. Similarly, link layer logic 372 may be provided to implement a base PCIe data link layer 382 and a CXL link layer (for CXI.io) representing an enhanced version of the PCIe data link layer 384. A CXL link layer 372 may also include cache and memory link layer enhancement logic 385 (e.g., for CXL.cache and CXL.mem).

Continuing with the example of FIG. 3B, a CXL link layer logic 372 may interface with CXL arbitration/multiplexing (ARB/MUX) logic 355, which interleaves the traffic from the two logic streams (e.g., PCIe/CXL.io and CXL.cache/CXL.mem), among other example implementations. During link training, the transaction and link layers are configured to operate in either PCIe mode or CXL mode. In some instances, a host CPU may support implementation of either PCIe or CXL mode, while other devices, such as accelerators, may only support CXL mode, among other examples. In some implementations, the port (e.g., a Flex Bus port) may utilize a physical layer 374 based on a PCIe physical layer (e.g., PCIe electrical PHY 386). For instance, a Flex Bus physical layer may be implemented as a converged logical physical layer 388 that can operate in either PCIe mode or CXL mode based on results of alternate mode negotiation during the link training process. In some implementations, the physical layer may support multiple signaling rates (e.g., 8 GT/s, 16 GT/s, 32 GT/s, etc.) and multiple link widths (e.g., x16, x8, x4, x2, x1, etc.). In PCIe mode, links implemented by the port may be fully compliant with native PCIe features (e.g., as defined in the PCIe specification), while in CXL mode, the link supports the features defined for CXL. Accordingly, a Flex Bus port may provide a point-to-point interconnect that can transmit native PCIe protocol data or dynamic multi-protocol CXL data to provide I/O, coherency, and memory protocols, over PCIe electricals, among other examples.

The CXL I/O protocol, CXL.io, provides a non-coherent load/store interface for I/O devices. Transaction types, transaction packet formatting, credit-based flow control, virtual channel management, and transaction ordering rules in CXL.io may follow all or a portion of the PCIe definition. CXL cache coherency protocol, CXL.cache, defines the interactions between the device and host as a number of requests that have at least one associated response message and sometimes a data transfer. The interface consists of three channels in each direction: Request, Response, and Data.

The CXL memory protocol, CXL.mem, is a transactional interface between the processor and memory and uses the physical and link layers of CXL when communicating across dies. CXL.mem can be used for multiple different memory attach options including when a memory controller is located in the host CPU, when the memory controller is within an accelerator device, or when the memory controller is moved to a memory buffer chip, among other examples. CXL.mem may be applied to transactions involving different memory types (e.g., volatile, persistent, etc.) and configurations (e.g., flat, hierarchical, etc.), among other example features. In some implementations, a coherency engine of the host processor may interface with memory using CXL.mem requests and responses. In this configuration, the CPU coherency engine is regarded as the CXL.mem Controller and the Mem device is regarded as the CXL.mem Subordinate. The CXL.mem Controller is the agent which is responsible for sourcing CXL.mem requests (e.g., reads, writes, etc.) and a CXL.mem Subordinate is the agent which is responsible for responding to CXL.mem requests (e.g., data, completions, etc.). When the Subordinate is an accelerator, CXL.mem protocol assumes the presence of a device coherency engine (DCOH). This agent is assumed to be responsible for implementing coherency related functions such as snooping of device caches based on CXL.mem commands and update of metadata fields. In implementations, where metadata is supported by device-attached memory, it can be used by the host to implement a coarse snoop filter for CPU sockets, among other example uses.

In some implementations, an interface may be provided to couple circuitry or other logic (e.g., an intellectual property (IP) block or other hardware element) implementing a link layer (e.g., 372) to circuitry or other logic (e.g., an IP block or other hardware element) implementing at least a portion of a physical layer (e.g., 374) of a protocol. For instance, an interface based on a Logical PHY Interface (LPIF) specification to define a common interface between a link layer controller, module, or other logic and a module implementing a logical physical layer (“logical PHY” or “logPHY”) to facilitate interoperability, design and validation re-use between one or more link layers and a physical layer for an interface to a physical interconnect, such as in the example of FIG. 3B. Additionally, as in the example of FIG. 3B, an interface may be implemented with logic (e.g., 381, 385) to simultaneously implement and support multiple protocols. Further, in such implementations, an arbitration and multiplexer layer (e.g., 355) may be provided between the link layer (e.g., 372) and the physical layer (e.g., 374). In some implementations, each block (e.g., 355, 374, 381, 385) in the multiple protocol implementation may interface with the other block via an independent interface (e.g., 392, 394, 396). In cases where bifurcation is supported, each bifurcated port may likewise have its own independent interface, among other examples.

CXL is a dynamic multi-protocol technology designed to support accelerators and memory devices. CXL.io is for discovery and enumeration, error reporting, peer-to-peer (P2P) access to CXL memory and host physical address (HPA) lookup. CXL.cache and CXL.mem protocols may be implemented by various accelerator or memory device usage models. An important benefit of CXL is that it provides a low-latency, high-bandwidth path for an accelerator to access the system and for the system to access the memory attached to the CXL device. The CXL 2.0 specification enabled additional usage models, including managed hot-plug, security enhancements, persistent memory support, memory error reporting, and telemetry. The CXL 2.0 specification also enables single-level switching support for fan-out as well as the ability to pool devices across multiple virtual hierarchies, including multi-domain support of memory devices. The CXL 2.0 specification also enables these resources (memory or accelerators) to be off-lined from one domain and on-lined into another domain, thereby allowing the resources to be time-multiplexed across different virtual hierarchies, depending on their resource demand. Additionally, the CXL 3.0 specification doubled the bandwidth while enabling still further usage models beyond those introduced in CXL 2.0. For instance, the CXL 3.0 specification provides for PAM-4 signaling, leveraging the PCIe Base Specification PHY along with its CRC and FEC, to double the bandwidth, with provision for an optional flit arrangement for low latency. Multi-level switching is enabled with the CXL 3.0 specification, supporting up to 4K Ports, to enable CXL to evolve as a fabric extending, including non-tree topologies, to the Rack and Pod level. The CXL 3.0 specification enables devices to perform direct peer-to-peer accesses to host-managed device memory (HDM) using Unordered I/O (UIO) (in addition to memory-mapped I/O (MMIO)) to deliver performance at scale. Snoop Filter support can be implemented in Type 2 and Type 3 devices to enable direct peer-to-peer accesses using the back-invalidate channels introduced in CXL.mem. Shared memory support across multiple virtual hierarchies is provided for collaborative processing across multiple virtual hierarchies, among other example features.

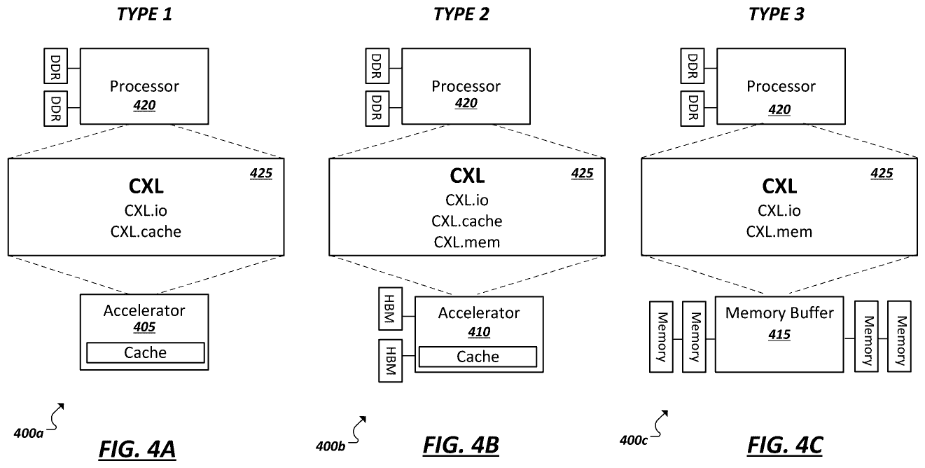

CXL may be used to interconnect peripheral devices that can be either traditional non-coherent I/O devices, memory devices, or accelerators with additional capabilities. When Type 2 and Type 3 device memory is exposed to the host, it is referred to as Host-managed Device Memory (HDM). The coherence management of this memory may be Host-only Coherent (HDM-H), Device Coherent (HDM-D), and Device Coherent using Back-Invalidation Snoop (HDM-DB). The host and device must have a common understanding of the type of HDM for each address region. FIGS. 4A-4C are simplified block diagrams 400a-c showing examples of CXL Type 1 devices (e.g., 405), Type 2 devices (e.g., 410), and Type 3 devices (e.g., 415). A CXL device (e.g., 405, 410, 415) may couple to a host processor (e.g., 420) via a CXL interconnect 425. Different CXL device types may utilize different combinations of the CXL protocols (or sub-protocols) (e.g., CXL.io, CXL.mem, CXL.cache).

In CXL, a “Type 1” devices have special needs for which having a fully coherent cache in the device becomes valuable. For such devices, standard producer-consumer ordering models do not work well. One example of a device with special requirements is to perform complex atomics that are not part of the standard suite of atomic operations present on PCIe. Basic cache coherency allows an accelerator to implement any ordering model it chooses and allows it to implement an unlimited number of atomic operations. These tend to require only a small capacity cache which can easily be tracked by standard processor snoop filter mechanisms. The size of cache that can be supported for such devices depends on the host's snoop filtering capacity. CXL supports such devices using its optional CXL.cache link over which an accelerator can use CXL.cache protocol for cache coherency transactions.

CXL “Type 2” devices, in addition to fully coherent cache, also have memory, for example DDR, High-Bandwidth Memory (HBM), or other memory attached to the device. These devices execute against memory, but their performance comes from having massive bandwidth between the accelerator and device-attached memory. One goal for CXL is to provide a means for the Host to push operands into device-attached memory and for the Host to pull results out of device-attached memory such that it does not add software and hardware cost that offsets the benefit of the accelerator. Systems may include coherent system address-mapped device-attached memory, also referred to as HDM with Device Managed Coherence (HDM-D/HDM-DB). There is an important distinction between HDM and traditional I/O and PCIe Private Device Memory (PDM). An example of such a device is a GPGPU with attached GDDR. Such devices have treated device-attached memory as private. This means that the memory is not accessible to the Host and is not coherent with the remainder of the system. It is managed entirely by the device hardware and driver and is used primarily as intermediate storage for the device with large data sets. A disadvantage to a model such as this is that it involves high-bandwidth copies back and forth from the Host memory to device-attached memory as operands are brought in and results are written back. Please note that CXL does not preclude devices with PDM.

At a high level, there are two example approaches of resolving device coherence of HDM. The first uses CXL.cache to manage coherence of the HDM and is referred to as “Device coherent.” The memory region supporting this flow is indicated with the suffix of “D” (HDM-D). The second approach uses the dedicated channel in CXL.mem called Back Invalidation Snoop and is indicated with the suffix “DB” (HDM-DB). With HDM-DB, the protocol enables new channels in the CXL.mem protocol that allow direct snooping by the device to the host using a dedicated Back-Invalidation Snoop (BISnp) channel. The response channel for these snoops is the Back-Invalidation Response (BIRsp) channel. The channels allow devices the flexibility to manage coherence by using an inclusive snoop filter tracking coherence for individual cache lines that may block new M2S Requests until BISnp messages are processed by the host.

A CXL “Type 3” device supports CXL.io and CXL.mem protocols. An example of a CXL Type 3 Device is a memory expander for the Host. Since this is not a traditional accelerator that operates on host memory, the device does not make any requests over CXL.cache. A passive memory expansion device would use the HDM-H memory region and while not directly manipulating its memory while the memory is exposed to the host. The device operates primarily over CXL.mem to service requests sent from the Host. The CXL.io protocol is used for device discovery, enumeration, error reporting and management. The CXL.io protocol is permitted to be used by the device for other I/O-specific application usages. The CXL architecture is independent of memory technology and allows for a range of memory organization possibilities depending on support implemented in the Host. Type 3 device Memory that is exposed as an HDM-DB enables the device to directly manage coherence with the host to enable in-memory computing and direct access using UIO on CXL.io. A Type 3 Multi-Logical Device (MLD) can partition its resources into up to multiple (e.g., 16) isolated Logical Devices. A Logical Device may be identified by a Logical Device Identifier (LD-ID) in CXL.io and CXL.mem protocols. A Logical Device visible to a Virtual Hierarchy (VH) may operate as a Type 3 device. The LD-ID is transparent to software. MLD components have common Transaction and Link Layers for each protocol across the LDs.

CXL is capable of maintaining memory coherency between the CPU memory space and memory on attached devices, so that any of the CPU cores or any of the other I/O devices configured to support CXL may utilize these attached memories and cache data locally on the same. Further, CXL allows resource sharing for higher performance, such that memory pooling may be achieved across different computing entities. Such CXL-enabled memory pools may enable enhanced and more efficient movement of operands. For instance, rather than utilizing DMA operation to transfer an entire segment of data from one computing element to the next computing element in association with a corresponding operation, coherent memory allows data to be moved seamlessly as if it were a simple transfer between the different cores in different CPU sockets. Such memory pooling can thus realize significant latency reduction and enable this aggregated memory in the system. Such features can enable more efficient memory usage, reduced architectural complexity, and thereby lower overall system costs. Further, such features allow programmers and system developers to focus on target workloads as opposed to redundant memory management, among other example benefits.

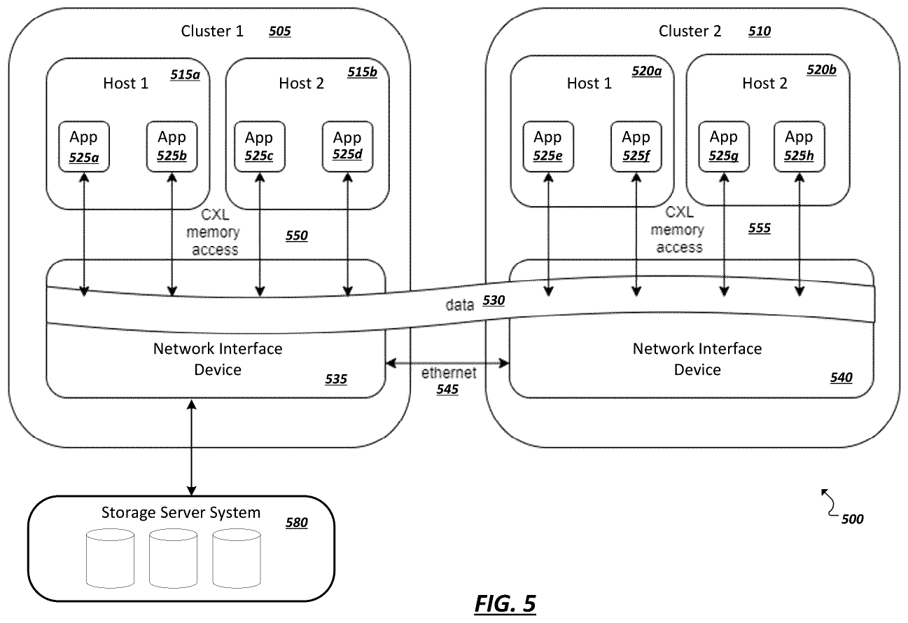

Improved node or cluster architectures may leverage the combined features of CXL and smart network interface devices (e.g., IPUs) to develop more efficient and better-performing service mesh clusters, which achieve these efficiencies with minimal movement of networking data and enhanced near memory processing. Such improved clusters can realize smaller latency, better resources utilization, and lower power consumption, among other example benefits. FIG. 5 is a simplified block diagram 500 illustrating a logical view of such a portion of such an improved cluster. As introduced above, a service mesh can be composed of one or multiple clusters (e.g., 505, 510). Host devices (e.g., 515a, 515b, 520a, 520b, etc.) may host various programs, services, microservices, or applications (e.g., 525a-h), which are executed on the corresponding host and which may share and operate various data on the service mesh. The data 530 moving within the cluster (e.g., including from memory and other compute resources from a storage server system 580) may be handled using the corresponding cluster's network interface device (e.g., 535, 540), with the network interface device further handling the inter-cluster communications and the internal connections of hosts and the network interface device within the cluster. Attached memory of the network interface device may be utilized to implement a memory pool for the cluster. Accordingly, data used in transactions within the cluster may be saved in the memory pool on the network interface device. Accordingly, when host device accesses the data within a transaction, the host device can utilize CXL memory accesses (e.g., 550, 555) to directly read or write data through the CXL cached memory as if it were local memory.

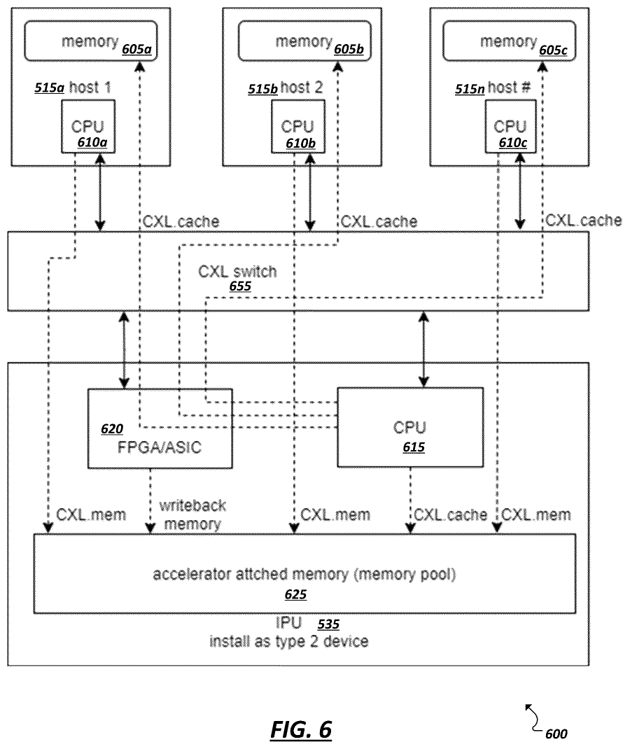

Turning to FIG. 6, a simplified block diagram 600 illustrating example hardware blocks of components within a cluster, such as the example shown in FIG. 5. For instance, a host device (e.g., 515a-n) may include respective local or attached memory (e.g., 605a-c) as well respective processing hardware 610a-c (e.g., CPU, FPGA, GPU, tensor processing unit (TPU), accelerator hardware, etc.), which may be utilized to host and execute various applications or portions of applications on the corresponding host. The host devices 515a-c may be connected to a CXL switch 655 for the cluster. The network interface device 535 of the cluster is also coupled to the switch 655. The network interface device 535 may include both a CPU 615 and programmable processing block 620 (e.g., a field programmable gate array (FPGA) or application-specific integrated circuit (ASIC)), together with attached memory 625, at least a portion of which is designated for use as a memory pool for the cluster.

In one example implementation, the network interface device 535 may be installed as a CXL type 2 device. Accordingly, the CPUs (e.g., 610a-c) of the hosts 515a-c, as well as the CPU (e.g., 615) of the network interface device 535, can cache (e.g., perform cacheable reads and cacheable writes of) the attached memory of the network interface device 535 using the CXL.mem subprotocol. The programmable processing block 620 of the network interface device 535 may cache the hosts' attached memory (e.g., 605a-c) using the CXL.cache subprotocol. Further, a dedicated hardware channel may be provided between the CPU 615 and programmable processing block 620 of the network interface device 535, allowing the CPU 615 to access the hosts' memories (e.g., 605a-c) through the programmable processing block 620 (e.g., also using the CXL.cache subprotocol), among other example features and implementations.

Data centers and data center networks continue to grow in prevalence and performance capabilities as cloud computing and other distributed computing architectures and systems grow in prevalence. With data center network speeds reaching 100 Gps and continuing to increase, conventional communication protocols may not be able to keep pace. For instance, the transmission control protocol (TCP) may struggle to provide the performance that cloud service providers need or desire to provide their respective services (e.g., infrastructure as a service (IaaS), software as a service (SaaS), platform as a service (PaaS), etc.). For instance, TCP may not be generally suited for latency sensitive processing due to its congestion management and retransmission control features, among other example issues. Further, data movement between memory, processors, and I/O devices struggle to meet the demands of memory intensive applications using traditional protocols.

Workloads handled by distributed computing architectures also continue to evolve. New workloads and applications challenge traditional data center assumptions and architectures. For instance, modern workloads may correspond to a set of microservices with various memory and bandwidth needs, with modern data centers struggling to accommodate dynamic changes in system configurations optimal for these various workloads and/or inefficiencies in reconfiguring system resources quickly between what can be short-lived microservice workloads. As additional examples, evolving machine learning and tensor processing workloads may require vastly different workloads from other more traditional applications. Data center designers traditionally face a choice: how to outfit a datacenter that is future proof and that can handle a wide range of applications or, alternatively, possesses specialized or custom capabilities optimized for select workload types.

Features of CXL and clusters and networks implemented using CXL offer a number of enhancements in how servers within a datacenter can communicate. Technologies like RDMA, that facilitate direct access of a remote node's memory, introduced the concept of availing direct access to a remote node's memory resources. Now, with CXL, this pushes the limits further by enabling modular system building to effectively plug-and-play various computing resources (e.g., caching devices/accelerators, accelerators with memory, and memory buffers) from a remote node to a given node. To accomplish such a system, however, considerations such as performance impacts, coherence requirements, quality of service, and other factors are to be considered and the system components configured accordingly. Modern system hardware lacks the logic to facilitate such system building.

In an improved system implementation, a data center cluster may be implemented utilizing CXL-based communication channels. For instance, a CXL-based data center cluster may include a number of host or endpoint computing devices (e.g., host devices, CPUs, graphic processors units (GPUs), tensor processing units (TPUs), hardware accelerators (e.g., accelerators for data compression, machine learning, deep learning, matrix processing, etc.), etc.) coupled to a network processor device (e.g., a smart NIC, data processing unit (DPU), IPU, programmable networking device, etc.). The network interface device may be utilized to accelerate the handling of network and memory traffic between the host devices and various remote resources. The network processor device may include a programmable processing block (e.g., an FPGA) to include the implementation of a network interface controller (NIC) that couples to these remote resources. The network interface device may additionally include a system on chip, CPU, or other processor to handle acceleration of network and memory handling. endpoint Traffic within the cluster and between clusters may be implemented and facilitated utilizing, which is connected to or even incorporates the CXL-based switch for the cluster. Local memory of the network processor device may be utilized to construct a shared memory pool for the cluster, which can be leveraged to facilitate efficient data transfers utilizing CXL. CXL enables a more efficient data transmission than TCP and RDMA between the processors and accelerators of the cluster. The network processor device may be configured with logic (implemented in hardware, firmware, and/or software) to perform near-data processing for the cluster and reduce the memory movement, to thereby provide more efficient performance in an improved service mesh cluster architecture. Such an architecture can be used to implement data center clusters with reduced memory movement between hosts, lower latency, improved resource utilization, and lower power consumption, among other example benefits.

In modern computing environments, software services and applications are increasingly deployed in a distributed manner. For instance, an application or service may be deployed and executed across multiple computing systems, with each of the multiple computing systems implementing a component (e.g., a microservice) of the overall service. For instance, an application or service in a service oriented architecture may be implemented according to a microservice architecture. The component microservices may be implemented on machines of differing technologies and may be programmed using different computing languages or technologies. Such architectures may benefit from platform flexibility, programmability, and modularity. Network processing devices, such as a IPUs, may be valuable tools in realizing such architectures (e.g., within cloud computing systems, data centers, etc.).

Cloud service providers (CSP), communications service providers (CoSP), and enterprises are investing heavily in hyper-scale data centers to deliver efficient computing for cloud-native applications and micro-services. However, infrastructure services such as storage and networking can consume a significant number of CPU cycles within the computing platforms utilized within such systems, diminishing the overall performance of the system.

Infrastructure Processing Units (IPUs) and other network processing devices may include circuitry to accelerate network and storage infrastructure within cloud and server computing platforms, freeing up CPU cores for improved application performance. For instance, IPUs may be used to provide virtIO-blk/NVMe storage functions to the host thereby offloading such storage services. The IPU effectively hides the backend implementation differences and adaptation needs, offloads the relevant adaptation logic, and more efficiently provides storage for the system. Traditionally, backend storage comes from remote storage service connected through a connection protocol network (e.g., iSCSI, Ceph, NVMe-oF).

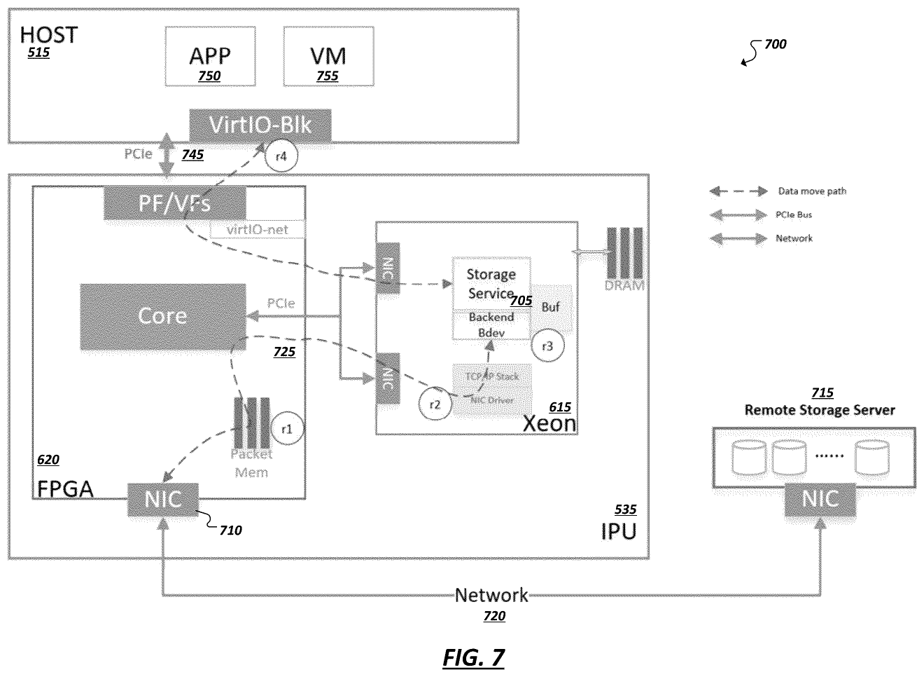

In one example implementation, an IPU device may include a programmable processing module (e.g., an FPGA module) and a CPU module. In some implementations, the CPU module may be implemented through a system on chip (SoC) device including one or more CPU cores (e.g., Xeon™ CPU). The FPGA and CPU may be utilized together to implement various services and functionality of the IPU. In some implementations, the IPU may be coupled to other storage devices (e.g., a remote storage server, a storage device coupled to the IPU by a point-to-point link, internal storage, etc.) and the IPU may be utilized to allow various host processors in a server architecture to access and use such memory utilizing storage input/output (I/O) processes and protocols. For instance, turning to the simplified block diagram 700 of FIG. 7, storage services 705 may be provided by the IPU 535 through modules executed on its CPU 615. A network interface controller (NIC) 710 may be included on the FPGA 620 and used to interface the IPU 535 with one or more external storage devices or systems (e.g., 715) over network 720. Data retrieved from the storage system through the FPGA is then passed on to the CPU for storage services processing, before being passed back to the FPGA for forwarding on to the host system(s) which may have requested or are otherwise to use the retrieved data. Typically, the storage I/O which reads from a remote storage server will transfer the data to the software stack (e.g., implementing networking and/or storage services) of the CPU 615 through a port of the FPGA 620 NIC port (e.g., following a data path 725 from r1 to r2), and the I/O will be parsed and accelerated by storage services 705 run in the CPU 615. In some implementations, the data will then be wrapped in protocol data (e.g., virtIO-blk, NVMe, etc.) before being transferred on to a host (e.g., 515) from the IPU 535 through its FPGA 620 (e.g., over a PCIe link 745). A host system 515 may utilize the IPU 535 to send and retrieve data over one or more networks (e.g., 720) for use by one or more applications (e.g., 750) run on virtual machines 755 or other operating environments (e.g., containers, operating systems, etc.) provided by the host system 515. In this case, however, the I/O path results in multiple data copies (at least 4 times in this example), which results in efficient use of resources and underwhelming I/O performance.

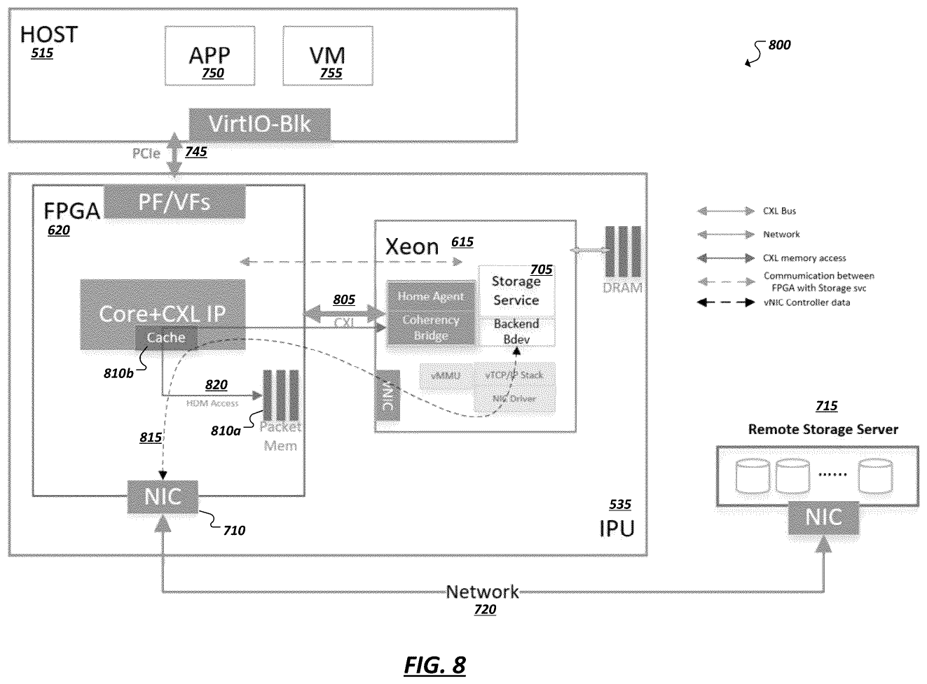

In an improved implementation, I/O performance of an IPU may be improved, enabling optimization and continuous acceleration of storage I/O performance in an IPU. While a remote direct memory access (RDMA) function in the NIC may be utilized between FPGA 620 and CPU 615 within some implementations of an IPU to eliminate the data copy in a kernel TCP/IP stack, RDMA still includes the copying of the data to a CPU storage service buffer, resulting in two additional data copies “from” and “to” the CPU in the IPU. In an improved implementation, a CXL link 805 may be implemented to interconnect the FPGA 620 and CPU 615 in an IPU 535, such as illustrated in the simplified block diagram 800 of FIG. 8. For instance, a CXL type 2 function in the FPGA may be utilized to enable no-copy direct memory access of data in the FPGA 620 by the CPU 615 in the IPU 535. Logic to support CXL may be provided in hardware of the FPGA 620 and/or CPU 615. In some implementations, one or more software or firmware patches may be deployed in the CPU 615 to support CXL and preserve compatibility with general TCP/IP protocol-supported applications, among other example features.

As shown in FIG. 8, the IPU FPGA 620 may be implemented as a CXL type 2 device from the view of the CPU 615, with the local memory resources 810a-b of the FPGA 620 exposed to the CPU 615. Accordingly, using CXL semantics, the CPU 615 can directly access the FPGA memory as a Host-managed Device Memory (HDM) access 820 according to CXL, with the coherency system in the CPU 615 ensuring the HDM memory access 820 as the system memory access to the DRAM from the CPU side. Further, I/O data reads from the remote storage server 715 can be cached in FPGA memory 810a and the storage service 705 in CPU 615 can execute the operands in this “remote” memory 810a and continue the storage acceleration without any additional data movement to the CPU 615. Additionally, for the CPU-side software, no actual data movement is included in the I/O path, but the network and I/O operations on this side of the kernel/software may be emulated (e.g., through patches added in the kernel to support a virtual MMU and virtual TCP/IP protocol). FIG. 8 shows a communication flow 815 between FPGA and CPU for support I/O handling and management utilizing the CXL link 805 instantiated between the FPGA 620 and CPU 615 in the IPU 535. This allows the overall I/O data path to be improved through reducing the number of data copies and thereby reducing the storage I/O latency and improving the I/O efficiency of the IPU 535.

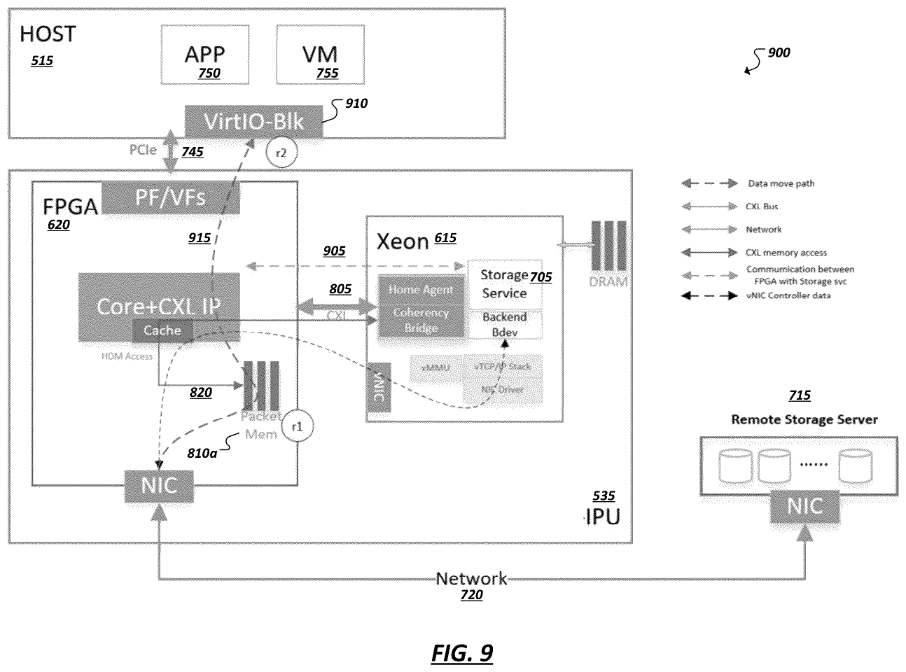

An improved network processing device, such as an IPU 535, may include CXL protocol hardware to implement CXL ports and a CXL link 805 between a programmable processing module (e.g., FPGA 620) and CPU/SOC 615. The FPGA 620 may be configured to support CXL type 2 functionality and couple to the CPU 615 element using a CXL link 805. Software enhancements may be implemented on the CPU 615 to adapt to the use of CXL to applications run on the CPU 615, such as through logic to adapt the TCP/IP stack for use with the CXL link 805. Further, a management protocol may be defined within the IPU 535 for the FPGA 620 and CPU 615 to communicate (e.g., via a sideband channel 905, as shown in FIG. 9) to support virtual network transmission without additional data copy, among other example features.

Turning to the simplified block diagram 900 of FIG. 9, an example detailed data flow 915 is shown between a CXL-enabled FPGA 620 (configured as a CXL type 2 device from the IPU CPU's view), where the memory resource 810a of the FPGA 620 is exposed to the CPU 615. The CPU 615 can access the FPGA memory 810a as a CXL-based HDM access, where coherency logic of the CPU 615 is used to ensure the HDM memory access 820 as the system memory access to the DRAM from the CPU side.

In the example of FIG. 9, an example I/O read operation is illustrated, which is initiated by a host system 515 (e.g., running an application, service, or microservice (e.g., 750) on an operating system, virtual machine, or container (e.g., 755) on the host 515). For instance, the host 515 may request particular data physically stored in remote memory (e.g., 715), but available through the IPU 535, and send the read I/O request to the IPU 535 on the FPGA 620 through a virtIO-blk driver 910 (e.g., based on the virtIO specification). A DMA engine in FPGA virto-blk IP block may fetch the virtIO-blk I/O request information structure to FPGA memory 810a to trigger the I/O handling process at the IPU 535. The FPGA 620 notifies (e.g., via a sideband message 905) the storage service 705 executed on the IPU CPU 615 to access the I/O request and parse the request, and reformat the request to the type which matches the backend storage protocol of the remote storage 715 from which the requested data is to be retrieved using the IPU 535. After the I/O request data in FPGA memory 810a is remapped, the CPU storage service 705 requests the FPGA 620 to send out the modified IO request to the remote storage 715 through the network 720 (coupled to the FPGA NIC). When the remote storage server 715 responds to the I/O request and sends back the I/O data to the IPU 535 for ultimate delivery to the requesting host 515, the I/O data read from the remote storage 715 is cached in FPGA memory (e.g., as NIC buffer data), which in traditional implementations would be fetched by the CPU's NIC driver to its TCP/IP stack. However, in the improved implementation illustrated in the example of FIG. 9, the I/O data (from the remote storage) remains in the FPGA memory 810a and is not copied to the CPU memory. Instead, the FPGA 620 sends a notification (e.g., via a sideband signaling channel 905) to the CPU 615 to let the CPU know of the arrival of the data (e.g., by indicating or pointing to its address in FPGA memory 910a) to allow the CPU 615 to access the data directly from the FPGA memory 810a using a CXL HDM access 820. Upon accessing the data, the CPU 615 may complete the additional processing to complete the networking transfer of the data from the IPU to the host without the need to copy the data to the CPU memory. For instance, the CPU-executed storage service 705 can perform its processing through the execution of the relevant storage service operands directly to the data while the data resides in FPGA memory 810a using CXL semantics and thereby allowing the storage acceleration facilitated by the CPU storage service logic 705. When the storage service data handling is completed, the CPU 615 may send a message (e.g., over the sideband channel 905) to the FPGA 620 to notify the FPGA 620 that the I/O data is ready to send on to the host 515. The FPGA 620, in one example, may prepare the IO data in FPGA memory 810a with a virtIO-Blk protocol wrapper and then send the data to the requesting host 515. In this example, only data copies are performed in the entire data path 915, thereby significantly reducing the latency overhead for such operations.

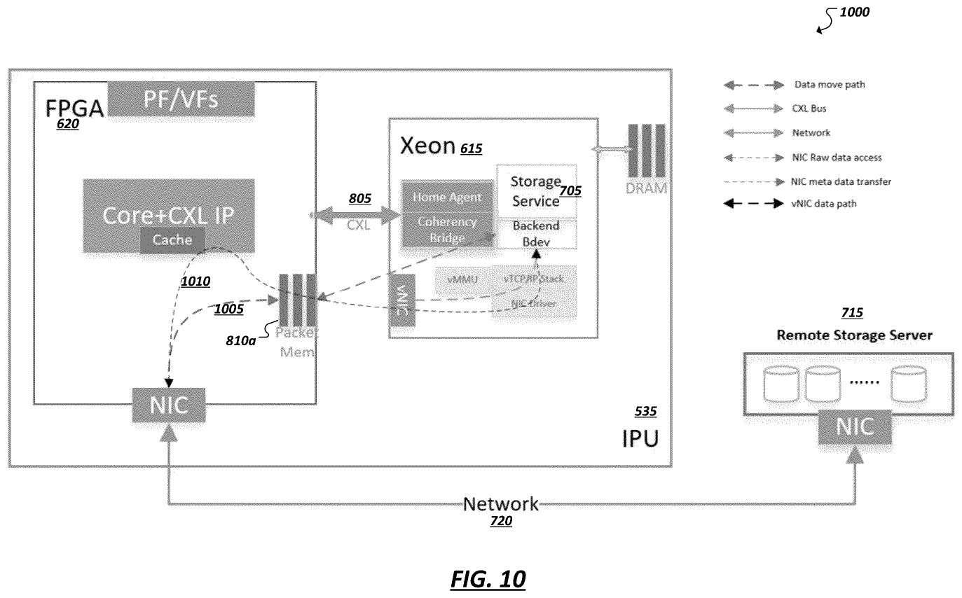

As noted above, at the software level, patches may be utilized in the CPU-side hardware to enhance support for this zero-copy network protocol, while still allowing the handling to be compatible with general TCP/IP supported software in the system. As shown in the simplified block diagram 1000 of FIG. 10, in the I/O path, the I/O data from remote storage may be transferred 1005 and kept in FPGA buffer memory, which appears like a NIC cache from the CPU's view. The software patches may enable the network and I/O operation to be emulated on the CPU kernel/software (e.g., to implement changes in the kernel to support a virtual MMU and virtualized TCP/IP protocol). The NIC data structure may be reformed to only transfer 1010 the data address to the CPU-based storage service without any data movement in the TCP/IP stack and between the CPU application and kernel, as illustrated by the flows illustrated in FIG. 10. The CPU-executed storage service can access (via a CXL link 805) and parse the I/O data with the received address.

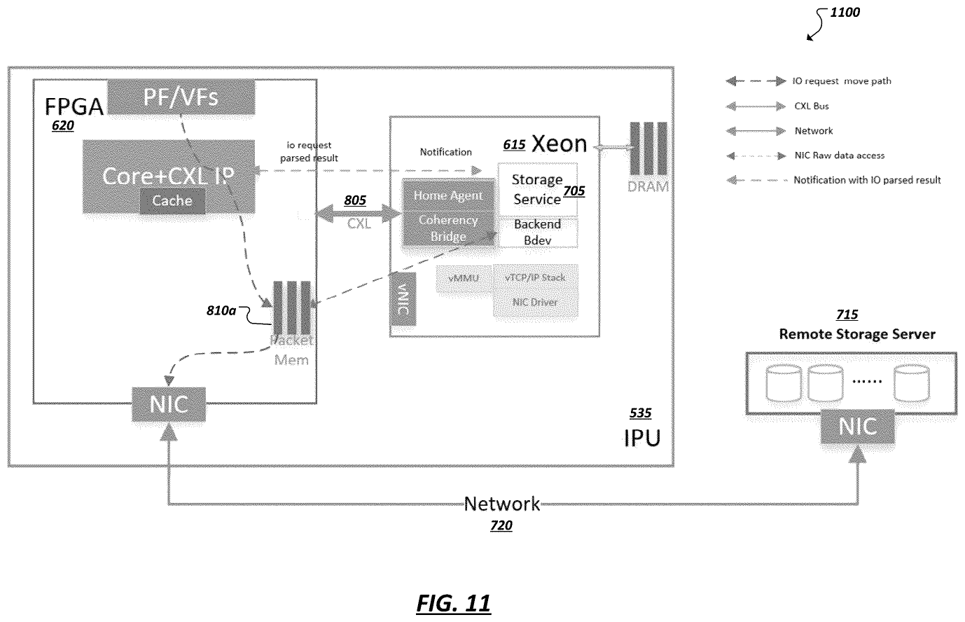

A communication protocol (e.g., sideband communication protocol) may be defined and implemented between the FPGA 620 and CPU 615 of the IPU 535 in parallel with the data accesses enabled by the CXL link 805 coupling the FPGA and CPU. In one example, the protocol may include the FPGA 620 sending a notification to the CPU 615 to request the CPU 615 storage service 705 to handle a particular I/O request, identify the location of the I/O request data in FPGA memory 810a and request the CPU 615 to parse the data and remap the data in accordance with the storage service 705 (e.g., among other example features and operations). Upon completion, the CPU 615 may send a message back to the FPGA 620 with information concerning the results of the I/O parsing, to alert the FPGA 620 that it may reengage with a requesting host and run the callback to continue the I/O process. For instance, as shown in the example illustrated in the simplified block diagram 1100 of FIG. 11, when the FPGA 620 receives an I/O request from a host device for a read operation, it may notify the storage service 705 in the CPU 615 with the I/O request structure address, to ask the storage service 705 to parse the I/O request according to the protocol of the associated backend storage, after which the CPU storage service 705 sends a message with the result to the FPGA buffer to trigger the FPGA's callback to continue the IO request to remote storage using the result generated by the CPU storage service 705.

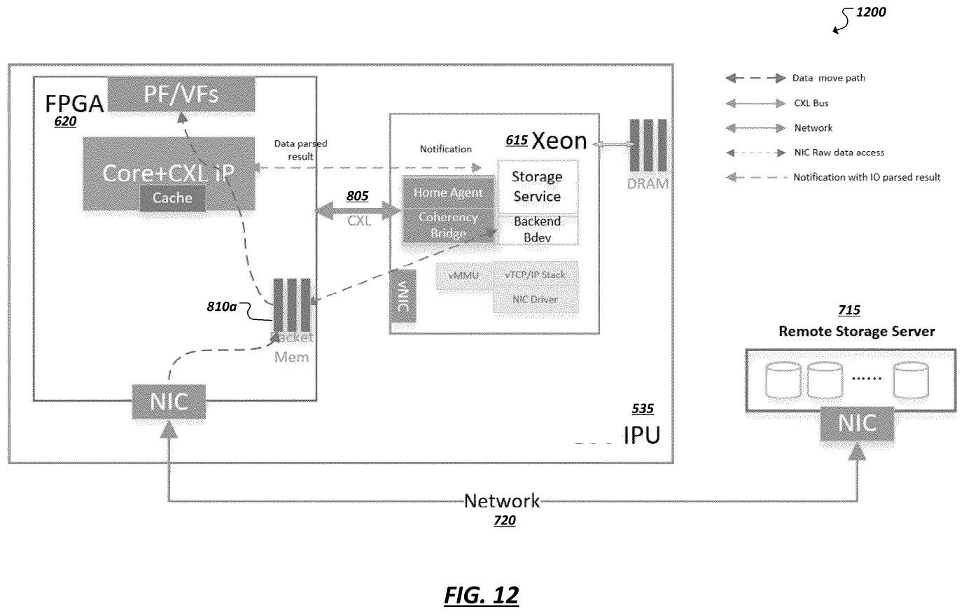

Turning to the simplified block diagram 1200 of FIG. 12, when the FPGA 620 receives data from a remote storage system 715 (e.g., in association with the request shown in the example of FIG. 11), the FPGA 620 may notify the storage service logic 705 of the CPU 615 with I/O meta data, to ask the storage service to parse the data. After the storage service parses the backend storage protocol and data, it may remap the I/O data to the associated raw data in the FPGA buffer (e.g., utilizing CXL HDM), then the storage service sends the result of its processing (or a report of its result) to the FPGA via a sideband message to trigger the FPGA's callback to wrap the IO data (e.g., based on a virtIO or NVME protocol) and send the data to upon host.

The direct data accesses provided through CXL may also be leveraged to decrease the data exchange overhead between host devices and the IPU in some implementations. In traditional implementations, an IPU (e.g., 535) may provide block storage to the host through virtual functions (VF) and/or physical functions (PF) (e.g., as defined in PCIe). Applications (e.g., Containers/VMs) on the host side can utilize the provisioned block storage and build their own file systems upon the block storage. This approach is feasible in some applications (e.g., Kubernetes) allowing the application to leverage container storage interface (CSI), for instance, to plugin the block storage provided by the IPU.

However, only providing block storage may be an insufficient solution in some implementations. For instance, in many applications (e.g., containers, Function as a service (FaaS), etc.), an application may be programmed with the expectation or requirement that it have access to the file system interface. In some implementations, an emulated file system may be implemented (e.g., to incorporate data in memory of an IPU accessible by a host), while minimizing the associated data exchange overhead between the host and IPU while accessing the emulated file system. While some solutions exist that allow for the emulation of file systems on shared or remote memory, such file system emulation may involve complex data transfers, including multiple data copies. In an improved implementation, a CXL link and corresponding protocol logic may be provided and leveraged to assist in eliminating much of the data exchange overhead between the host and IPU during file system emulation.

In some implementations, a virtIO-based virtual file system (e.g., virtIO-fs) may be utilized and supported by logic of the IPU and host. In such examples, when an application in the host side opens a file in the emulated file system and issues reads and/or writes on the file, the request may be encapsulated in virtIO-fs (or another file system emulation protocol wrapper). In some instances, this file system emulation request may be sent over a PCIe “request command” or according to a FUSE format, where the IPU copies the data from the host side and conducts the file system operations inside the IPU, thereafter responding to the read/write request using a virtIO-fs over PCIe “response format”. This approach results in considerable overhead, however, in implementing the virtual file system.

In an enhanced system implementation, processing utilized in the implementation of an emulated file system may be improved. For instance, during emulated file-system device (e.g., FS-dev) setup, the host and IPU may negotiate and register the memory regions which may be accessed by both the host and IPU. In some implementations, these shared memory regions may include a memory region containing page cache and allocated in the physical memory attached to the host or in the IPU's attached physical memory. In some implementations, the memory region(s) to be used between the host and IPU may be owned by the host side with physical attached memory (DRAM), as this may allow advantages such as limiting the amount of changes to the application's behavior. In such implementations, the IPU should also have access to this memory space, allowing the IPU to fetch data (e.g., page cache data) from the host's memory the CXL-implemented DMA. In one implementation, the IPU (or DPU, smart NIC, or other networking accelerator) is implemented and configured at least as a CXL type 1 device or a CXL type 2 device. Type 1 CXL devices, for instance, may be implemented as caching devices such as accelerators and Smart NICs, IPUs, or DPUs. The Type 1 device can access the host memory through a CXL link, then cache transactions and maintain a local cache that is coherent with the host memory. If the IPU/DPU is a CXL type 2 device, the local address space of the IPU may be used and made visible and accessible to the host CPU through the CXL link. In such instances, the IPU may control the policy to map those memory regions with the right privileges.

A CXL link coupling the IPU and host may be utilized, in either the CXL type 1 device or type 2 device implementation, to enable the direct exchange of data between the IPU and host relating to file system emulation (e.g., according to virtIO-fs) through CXL's memory access policy. For instance, for read/write operations associated with the emulated filesystem, the IPU may use the CXL-defined direct memory access policies to access the corresponding memory pages via DMA-related polices. Such an approach can eliminate the memory copy overhead, such as would be the case in PCIe-based implementations, for instance. In some implementations, FPGA IP blocks may be utilized to implement at least a portion of the CXL-based channel to conduct the exchange between the host and IPU, among other example implementations. Generally, CXL may be leveraged to accelerate the data exchange for emulated file systems through efficient page cache sharing.

Emulated or virtual file systems may enable a variety of benefits. While a file system may be implemented by having the IPU provide block storage to the host (e.g., with the IPU providing block storage to the applications (e.g., normal processes, virtual machines, etc.) to via physical functions (PFs) or virtual functions (VFs), the host still needs to build its own file system. Accordingly, there is no offloading for the file system related operations. In most cases, the host will consume many CPU cycles to deal with the file system-related operations. In other implementations, the IPU can offload the container image operation and construct the bundle for the containers (e.g., the root file system of the containers) to offload building of the file system by the host, however, this approach does not allow the host and IPU to share the same page cache. Compared with the virtIO-fs sharing between guest OS and host OS usage, this will dramatically influence the performance, among other example issues. An improved implementation, such as discussed herein, where CXL-based DMA is utilized in the emulation or virtualization of a file system between a host and IPU, allows the page cache to be shared between the host and IPU, thus improving the overhead and overall performance of the file system access.

In one example, the performance of the consuming virtIO-fs device is improved in the host simulated by IPU/DPU. This may be facilitated by CXL's (e.g., type 1 or type 2 device) capability to allow fast access of a shared memory region. Associated memory copies can thus be eliminated when conducting virtIO-fs request or response from host and/or IPU side. This approach allows unnecessary data copies to be reduced and thereby improves overall performance by allowing the host and IPU to efficiently share the common page cache memory region.

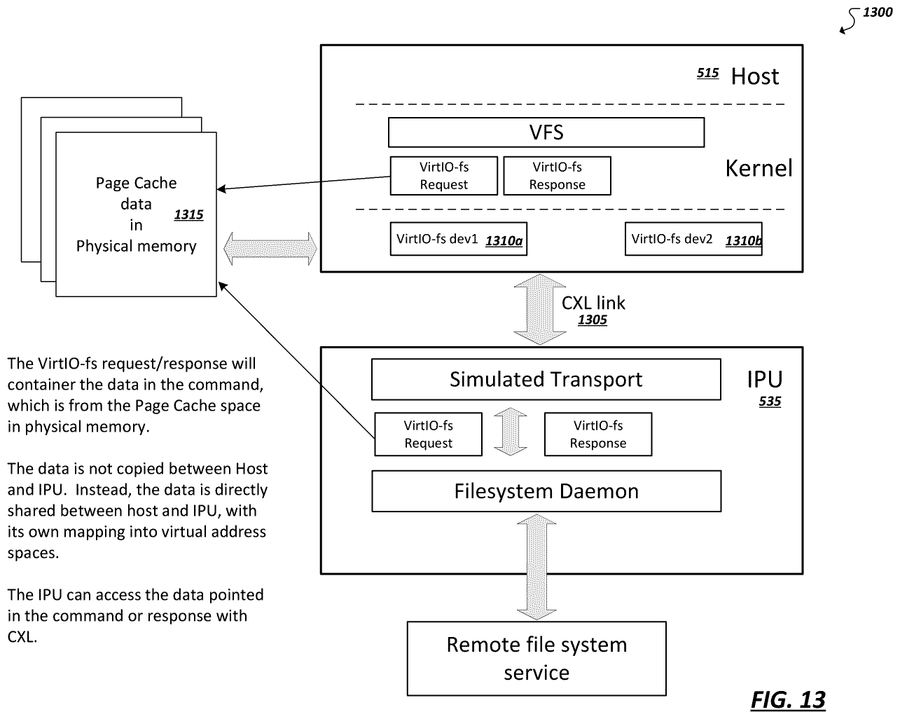

Turning to the simplified block diagram 1300 of FIG. 13, an example IPU 535 is connected to a host device 515 via a link 1305 compliant with a CXL-based protocol (e.g., CXL protocol via PCIe 5.0 or 6.0). The IPU 535 is implemented as either a CXL type 1 or type 2 device and provides the emulated file system through a virtIO-fs device logic block. The use of the CXL link 1305 and associated CXL DMA semantics allow the virtIO-fs device performance to be accelerated. The host 515 and IPU 535 may communicate to negotiate the provisioning and configuration of the virtIO-fs device (e.g., 1310a,b) on the host 515, including the definition and registration of one or more page cache memory ranges (e.g., 1315) in memory of the IPU or the host. For instance, in the case of using page cache memory 1315 in the host-attached physical memory (and utilizing the IPU 535 as a CXL type 1 device), the host 515 may reserve the associated memory ranges for use in the emulated file system and pass an identification of these to the IPU 535. In one illustrative example, the memory range definition can be defined according to: <base_address, length, read/write/privileges>, during the negotiation between the host 515 and IPU 535 and appropriate address translations may be performed (e.g., using address translation service (ATS)).

In the case of host memory being used in the file system emulation, the IPU 535 and host 515 may appropriately negotiate the memory range (in page cache memory) to be used in the file system emulation. The IPU 535 may then identify the reserved memory ranges and map the corresponding physical addresses to its own virtual memory addresses. Thus, the OS kernel in the host 515 and the OS in the IPU 535 can see the same memory range. In the example of virtIO-fs protocol, a ring-based approach may be utilized, so when the host 515 submits the request, IPU will not touch and interfere with the same memory regions, among other example features.

Continuing with the above example, when the host side sends a virtIO-fs request (e.g., fuse command is encapsulated) with data, the IPU does not copy the data from the host side. Instead, the IPU uses CXL semantics to directly access the related data pointed in the shared page cache memory region by the virtIO-fs request command using CXL link 1305 and completes the file system related request by using CXL to direct-write to (another address in) the shared page cache 1315. More particularly, when the IPU side sends a virtIO-fs response (e.g., fuse command is encapsulated) with data, the IPU directly writes the data in the shared page cache memory region using CXL DMA semantics and lets the response command point the offset in the page cache memory region to alert the host 515 of the location of the response in the page cache 1315. Accordingly, following the filesystem operation completion notification, the host side software can directly access the data in the page cache memory regions 1315. As a result, virtIO-fs transactions between the IPU and host may be completed using a zero memory copy approach.

A similar technique may be employed when the IPU is used as a CXL type 2 device and its memory is used for the shared page cache 1315. For instance, the host side may use CXL semantics to directly write to the memory of the IPU 535 over the CXL link 1305 to send a virtIO-fs request with data and may similarly access virtIO-fs responses generated by the IPU 535 directly from IPU memory using CXL type 2 transactions in order to preserve the zero memory copy approach for file system emulation between the host (and its applications) and the IPU.

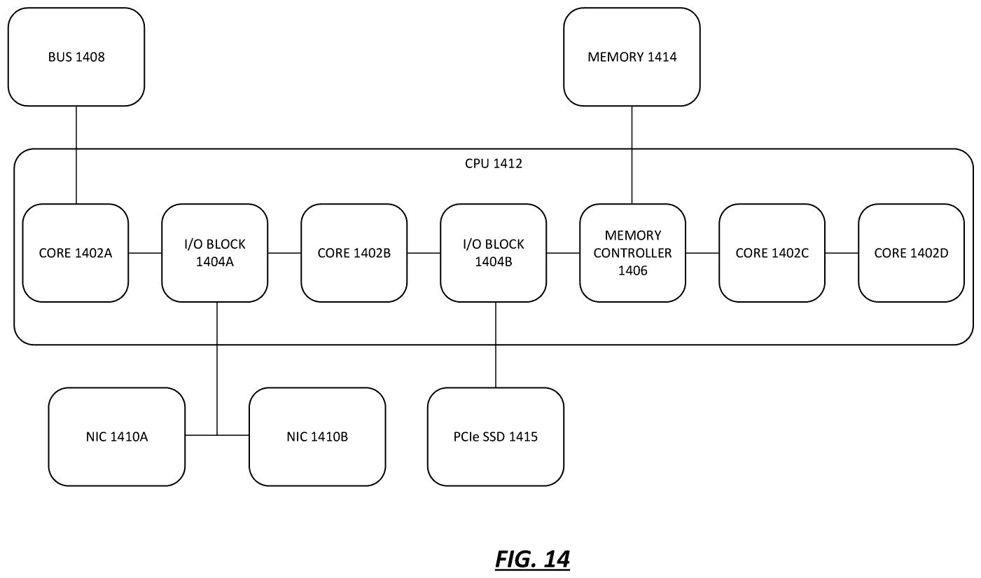

Note that the apparatus', methods', and systems described above may be implemented in any electronic device or system as aforementioned. As a specific illustration, FIG. 14 provides an exemplary implementation of a processing device such as one that may be included in a network interface device. It should be appreciated that other processor architectures may be provided to implement the functionality and processing of requests by an example network interface device, including the implementation of the example network interface device components and functionality discussed above. Further, while the examples discussed above focus on the use of CXL and CXL-based protocols, it should be appreciated that reference to CXL is as an illustrative example only. Indeed, the more generalized concepts disclosed herein may be equally and advantageously applied to other interconnects and interconnect protocols that facilitate similar features, among other examples.

Referring to FIG. 14, a block diagram is shown of an example data processor device (e.g., a central processing unit (CPU)) 1412 coupled to various other components of a platform in accordance with certain embodiments, such as those discussed above. Although CPU 1412 depicts a particular configuration, the cores and other components of CPU 1412 may be arranged in any suitable manner. CPU 1412 may comprise any processor or processing device, such as a microprocessor, an embedded processor, a digital signal processor (DSP), a network processor, an application processor, a co-processor, a system on a chip (SOC), or other device to execute code. CPU 1412, in the depicted embodiment, includes four processing elements (cores 1402 in the depicted embodiment), which may include asymmetric processing elements or symmetric processing elements. However, CPU 1412 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1412, as illustrated in FIG. 14, includes four cores-cores 1402A, 1402B, 1402C, and 1402D, though a CPU may include any suitable number of cores. Here, cores 1402 may be considered symmetric cores. In another embodiment, cores may include one or more out-of-order processor cores or one or more in-order processor cores. However, cores 1402 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1402 may include a decode module coupled to a fetch unit to decode fetched elements. Fetch logic, in one embodiment, includes individual sequencers associated with thread slots of cores 1402. Usually, a core 1402 is associated with a first ISA, which defines/specifies instructions executable on core 1402. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 1402 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1402, in one embodiment, recognize the same ISA (or a subset thereof). Alternatively, in a heterogeneous core environment, a decoder of one or more cores (e.g., core 1402B) may recognize a second ISA (either a subset of the first ISA or a distinct ISA).

In various embodiments, cores 1402 may also include one or more arithmetic logic units (ALUs), floating point units (FPUs), caches, instruction pipelines, interrupt handling hardware, registers, or other suitable hardware to facilitate the operations of the cores 1402.

Bus 1408 may represent any suitable interconnect coupled to CPU 1412. In one example, bus 1408 may couple CPU 1412 to another CPU of platform logic (e.g., via UPI). I/O blocks 1404 represents interfacing logic to couple I/O devices 1410 and 1415 to cores of CPU 1412. In various embodiments, an I/O block 1404 may include an I/O controller that is integrated onto the same package as cores 1402 or may simply include interfacing logic to couple to an I/O controller that is located off-chip. As one example, I/O blocks 1404 may include PCIe interfacing logic. Similarly, memory controller 1406 represents interfacing logic to couple memory 1414 to cores of CPU 1412. In various embodiments, memory controller 1406 is integrated onto the same package as cores 1402. In alternative embodiments, a memory controller could be located off chip.

As various examples, in the embodiment depicted, core 1402A may have a relatively high bandwidth and lower latency to devices coupled to bus 1408 (e.g., other CPUs 1412) and to NICs 1410, but a relatively low bandwidth and higher latency to memory 1414 or core 1402D. Core 1402B may have relatively high bandwidths and low latency to both NICs 1410 and PCIe solid state drive (SSD) 1415 and moderate bandwidths and latencies to devices coupled to bus 1408 and core 1402D. Core 1402C would have relatively high bandwidths and low latencies to memory 1414 and core 1402D. Finally, core 1402D would have a relatively high bandwidth and low latency to core 1402C, but relatively low bandwidths and high latencies to NICs 1410, core 1402A, and devices coupled to bus 1408.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a network interface device including: a port including protocol circuitry to couple to a host device by a link, where the link is compliant with a Compute Express Link (CXL) protocol; a memory; and logic to support emulation of a file system by the host device of at least a portion of the memory, where the link is used for direct memory accesses for requests or responses associated with the emulation of the file system.

Example 2 includes the subject matter of example 1, where the network interface device further includes a programmable processor, a second processor device, and a network port to couple the network interface device to a network.

Example 3 includes the subject matter of example 2, where the programmable processor is coupled to the central processing units by a second CXL link.

Example 4 includes the subject matter of example 3, where data exchanged between the programmable processor and the second processor over the second CXL link includes a zero copy data exchange.

Example 5 includes the subject matter of any one of examples 2-4, where the second processor includes acceleration logic to perform memory services or network services on data to be passed between the network and the host device over the network interface device.

Example 6 includes the subject matter of example 5, where the acceleration logic performs the memory services or network services directly on memory of the programmable processor through a CXL Host-managed Device Memory (HDM) access. accessed through the network port from remote data storage.

Example 7 includes the subject matter of any one of examples 2-6, where the programmable processor is to receive particular data on the network and copy the particular data to the memory, where the first processing device reads the particular data from the memory using CXL semantics without copying the particular data to memory of the first processing device, and the acceleration logic is to determine a result from the particular data.

Example 8 includes the subject matter of any one of examples 2-7, where the network interface device includes an infrastructure processing unit (IPU).

Example 9 includes the subject matter of any one of examples 2-8, where the programmable processor includes a network interface controller (NIC) and the NIC includes the network port.

Example 10 includes the subject matter of any one of examples 1-9, where the network interface device is configured as a Type 1 CXL device.

Example 11 includes the subject matter of example 10, where page cache of the host device is used to exchange the requests or responses associated with emulation of the file system between the network interface device and the host device.

Example 12 includes the subject matter of any one of examples 1-9, where the network interface device is configured as a Type 2 CXL device.

Example 13 includes the subject matter of example 12, where page cache in the memory of the network interface device is used to exchange the requests or responses associated with emulation of the file system between the network interface device and the host device.

Example 14 includes the subject matter of example 13, where the host device writes the requests to the page cache and reads responses from the page cache through a CXL HDM access.

Example 15 includes the subject matter of any one of examples 1-14, where the file system is emulated in user space of the host device.

Example 16 includes the subject matter of example 15, where the file system is emulated based on a Filesystem in Userspace (FUSE)-based architecture.

Example 17 includes the subject matter of example 16, where the requests or the responses associated with the emulations of the file system are based on a virtIO-fs protocol.

Example 18 is a method including: identifying, by a network interface device, a request associated with an emulation of a file system by a host device, where the request is written directly to page cache of the network interface device by the host device over a link coupling the network interface device to the host device, where the link is compliant with a Compute Express Link (CXL) protocol; and generating, at the network interface device, a response to the request, where the response is associated with the emulation of the file system by the host device, and the host device is to directly read to response from the page cache of the network interface device using the link based on the CXL protocol.

Example 19 is a system including means to perform the method of example 18.

Example 20 is a system including: a host device including a processor to: execute one or more applications; and execute an emulation of a file system for the one or more applications; and a network interface device coupled to the host device by a link, where the link is compliant with a Compute Express Link (CXL) protocol, and the network interface device includes: a memory, where at least a portion of data in the memory is to be included in the emulation of the file system; and logic to: access a request from the host device associated with the emulation of the file system, where the request is provided through a direct memory access to shared page cache based on the CXL protocol; and generate a response to the request, where the response is provided to the host device through another direct memory access to the shared page cache.

Example 21 includes the subject matter of example 20, where the request and response are based on a virtIO protocol.

Example 22 includes the subject matter of example 20, where the network interface device further includes a programmable processor, a second processor device, and a network port to couple the network interface device to a network.

Example 23 includes the subject matter of example 22, where the programmable processor is coupled to the central processing units by a second CXL link.

Example 24 includes the subject matter of example 23, where data exchanged between the programmable processor and the second processor over the second CXL link includes a zero copy data exchange.

Example 25 includes the subject matter of any one of examples 22-24, where the second processor includes acceleration logic to perform memory services or network services on data to be passed between the network and the host device over the network interface device.

Example 26 includes the subject matter of example 25, where the acceleration logic performs the memory services or network services directly on memory of the programmable processor through a CXL Host-managed Device Memory (HDM) access. accessed through the network port from remote data storage.

Example 27 includes the subject matter of any one of examples 22-26, where the programmable processor is to receive particular data on the network and copy the particular data to the memory, where the first processing device reads the particular data from the memory using CXL semantics without copying the particular data to memory of the first processing device, and the acceleration logic is to determine a result from the particular data.

Example 28 includes the subject matter of any one of examples 22-27, where the network interface device includes an infrastructure processing unit (IPU).

Example 29 includes the subject matter of any one of examples 22-28, where the programmable processor includes a network interface controller (NIC) and the NIC includes the network port.

Example 30 includes the subject matter of any one of examples 21-29, where the network interface device is configured as a Type 1 CXL device.

Example 31 includes the subject matter of example 30, where page cache of the host device is used to exchange the requests or responses associated with emulation of the file system between the network interface device and the host device.

Example 32 includes the subject matter of any one of examples 21-29, where the network interface device is configured as a Type 2 CXL device.

Example 33 includes the subject matter of example 32, where page cache in the memory of the network interface device is used to exchange the requests or responses associated with emulation of the file system between the network interface device and the host device.

Example 34 includes the subject matter of example 33, where the host device writes the requests to the page cache and reads responses from the page cache through a CXL HDM access.

Example 35 includes the subject matter of any one of examples 21-34, where the file system is emulated in user space of the host device.

Example 36 includes the subject matter of example 35, where the file system is emulated based on a Filesystem in Userspace (FUSE)-based architecture.

Example 37 is an apparatus including: a network interface device including: a first processing device, where the first processing device includes acceleration logic; and a second processing device, where the second processing device includes a programmable processor device, and including: network port; a memory; a Compute Express Link (CXL) port to couple to the first processing device through a CXL link.

Example 38 includes the subject matter of example 37, where a portion of the memory is exposed to the first processing device as CXL Host-managed Device Memory (HDM).

Example 39 includes the subject matter of any one of examples 37-38, where data is exchanged between the first processing device over the CXL link includes zero copy data exchange.

Example 40 includes the subject matter of any one of examples 37-39, where the acceleration logic is to perform memory services on data to be accessed through the network port from remote data storage.

Example 41 includes the subject matter of any one of examples 37-40, where the acceleration logic is to perform networking services on data to be accessed through the network port from remote data storage.

Example 42 includes the subject matter of any one of examples 37-41, where the second processing device is to receive particular data and copy the particular data to the memory, where the first processing device reads the particular data from the memory using CXL semantics without copying the particular data to memory of the first processing device, and the acceleration logic is to determine a result from the particular data.

Example 43 includes the subject matter of example 42, where the result is sent to the second processing device over a sideband channel.

Example 44 includes the subject matter of example 42, where the result is written to the memory directly by the first processing device using the CXL link.

Example 45 includes the subject matter of any one of examples 42-44, where the second processing device sends a notification of receipt of the particular data to the first processing device, and the notification includes a pointer to the memory.

Example 46 includes the subject matter of example 45, where the second processing device sends the notification over a sideband channel.

Example 47 includes the subject matter of any one of examples 42-45, where the particular data is received from a remote data server over the network port.

Example 48 includes the subject matter of any one of examples 42-45, where the particular data is received from a host device coupled to the network interface device by a link.

Example 49 includes the subject matter of any one of examples 37-48, where the network interface device includes one of an infrastructure processing unit (IPU) or a smart network interface card (smart NIC).

Example 50 includes the subject matter of any one of examples 37-49, where the second processing device includes a field programmable gate array (FPGA) device.

Example 51 includes the subject matter of any one of examples 37-50, where the first processing device includes a central processing unit (CPU).

Example 52 is a method including: receiving data, at a network interface device, from another device; writing the data to memory of a programmable processor device in the network interface device; notifying the CPU of the data; directly accessing, at a central processing unit (CPU), the data in the memory of the programmable processor device using a CXL link coupling the CPU to the programmable processor device; and performing tasks using the data at the CPU.

Example 53 is a system including means to perform the method of example 52.

Example 54 is a system including the apparatus of any one of examples 1-15 or examples 37-51.

Example 55 includes the subject matter of example 54, further including a host device coupled to the network interface device.

Example 56 includes the subject matter of example 55, further including a data storage system coupled to the network interface device.

Example 57 is a system including means to emulate a file system between a host processor device and a network interface device, where the host processor device and the network interface device are coupled by a CXL-based interconnect.

Example 58 is a system including the apparatus of any one of examples 1-15 or examples 37-51.

Example 59 includes the subject matter of example 58, further including the host processor device.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a network interface device comprising:
an interface comprising protocol circuitry to couple to a host device by a link, wherein the link is compliant with a Compute Express Link (CXL) protocol;
a memory; and
logic to support emulation of a file system by the host device of at least a portion of the memory, wherein the link is used for memory accesses for requests or responses associated with the emulation of the file system.

2. The apparatus of claim 1, wherein the network interface device further comprises a programmable processor, a second processor device, and a network port to couple the network interface device to a network.

3. The apparatus of claim 2, wherein the programmable processor is coupled to the central processing units by a second CXL link.

4. The apparatus of claim 3, wherein data exchanged between the programmable processor and the second processor over the second CXL link comprises a zero copy data exchange.

5. The apparatus of claim 2, wherein the second processor comprises acceleration logic to perform memory services or network services on data to be passed between the network and the host device over the network interface device.

6. The apparatus of claim 5, wherein the acceleration logic performs the memory services or network services directly on memory of the programmable processor through a CXL Host-managed Device Memory (HDM) access. accessed through the network port from remote data storage.

7. The apparatus of claim 2, wherein the programmable processor is to receive particular data on the network and copy the particular data to the memory, wherein the first processing device reads the particular data from the memory using CXL semantics without copying the particular data to memory of the first processing device, and the acceleration logic is to determine a result from the particular data.

8. The apparatus of claim 2, wherein the network interface device comprises an infrastructure processing unit (IPU).

9. The apparatus of claim 2, wherein the programmable processor comprises a network interface controller (NIC) and the NIC comprises the network port.

10. The apparatus of claim 1, wherein the network interface device is configured as a Type 1 CXL device.

11. The apparatus of claim 10, wherein page cache of the host device is used to exchange the requests or responses associated with emulation of the file system between the network interface device and the host device.

12. The apparatus of claim 1, wherein the network interface device is configured as a Type 2 CXL device.

13. The apparatus of claim 12, wherein page cache in the memory of the network interface device is used to exchange the requests or responses associated with emulation of the file system between the network interface device and the host device.

14. The apparatus of claim 13, wherein the host device writes the requests to the page cache and reads responses from the page cache through a CXL HDM access.

15. The apparatus of claim 1, wherein the file system is emulated in user space of the host device.

16. The apparatus of claim 15, wherein the file system is emulated based on a Filesystem in Userspace (FUSE)-based architecture.

17. The apparatus of claim 16, wherein the requests or the responses associated with the emulations of the file system are based on a virtIO-fs protocol.

18. A method comprising:
identifying, by a network interface device, a request associated with an emulation of a file system by a host device, wherein the request is written directly to page cache of the network interface device by the host device over a link coupling the network interface device to the host device, wherein the link is compliant with a Compute Express Link (CXL) protocol; and
generating, at the network interface device, a response to the request, wherein the response is associated with the emulation of the file system by the host device, and the host device is to directly read to response from the page cache of the network interface device using the link based on the CXL protocol.

19. A system comprising:
a host device comprising a processor to:
execute one or more applications; and
execute an emulation of a file system for the one or more applications; and
a network interface device coupled to the host device by a link, wherein the link is compliant with a Compute Express Link (CXL) protocol, and the network interface device comprises:
a memory, wherein at least a portion of data in the memory is to be included in the emulation of the file system; and
logic to:
access a request from the host device associated with the emulation of the file system, wherein the request is provided through a direct memory access to shared page cache based on the CXL protocol; and
generate a response to the request, wherein the response is provided to the host device through another direct memory access to the shared page cache.

20. The system of claim 19, wherein the request and response are based on a virtIO protocol.
